(19) United States
(12) Patent Application Publication
(10) Pub. No.: US 2026/0231737 A1
(43) Pub. Date: Aug. 6, 2026

(54) STACKED STRUCTURE AND DESIGN METHOD OF ITS BONDING LAYER

(71) Applicant: Winbond Electronics Corp., Taichung City (TW)

(72) Inventors: Chun-Hung Lin, Chiayi City (TW); Yu-Cheng Chen, Kaohsiung City (TW); Jin-Neng Wu, Kaohsiung City (TW); Jun Ji Su, Tainan City (TW)

(73) Assignee: Winbond Electronics Corp., Taichung City (TW)

(21) Appl. No.: 19/392,184

(22) Filed: Nov. 18, 2025

(30) Foreign Application Priority Data
Feb. 3, 2025 (TW) 114103895

(51) Int. Cl. H10P 74/00; H10P 74/20; H10W 72/90; H10W 90/00

(52) U.S. Cl. CPC H10P 74/273; H10P 74/207; H10W 72/926; H10W 72/936; H10W 72/9445; H10W 90/792

(57) ABSTRACT

Provided are a stacked structure and a design method of its bonding layer, and the design method includes the following. A first stacked structure formed by stacking and bonding of multiple wafers is provided. The first stacked structure includes die regions, bonding test regions, and scribe lines. The scribe lines separate the die regions, and the bonding test regions are located in the scribe lines. Each bonding test region includes a test circuit. The test circuit includes conductive bonding structures formed by bond pads of wafers bonding to each other. The bond pads in each bonding test region have different design parameters. Electrical performance test is conducted on the test circuit of each bonding test region of the first stacked structure. A range of applicable design parameters for bond pads in the die regions of the first stacked structure is determined by a test result of the electrical performance test.

### CROSS-REFERENCE TO RELATED APPLICATION

This application claims the priority benefit of Taiwan application serial no. 114103895, filed on February 3, 2025. The entirety of the above-mentioned patent application is hereby incorporated by reference herein and made a part of this specification.

### BACKGROUND

### TECHNICAL FIELD

The disclosure relates to a structure and a design method thereof, and particularly relates to a stacked structure and a design method of its bonding layer.

### Related Art

Generally, in order to achieve high-efficiency computing, multiple wafers are stacked together to form a stacked structure. In the front-end process, the process window may be determined or verified through automated tools of the equipment. However, in the back-end bonding process, the automated tools cannot be used for determination, making it difficult to estimate bonding process-related parameters, such as design parameters of bond pads, process parameters of the bonding process, and the quantity of stacked wafers. Once bonding fails during the design test process, the batch of stacked structures is lost and corresponding design modifications need to be made to the layout of the die region, resulting in increased design costs and low execution efficiency. Therefore, how to improve the design of the bonding layer of the stacked structure is a current target for improvement.

### SUMMARY

The disclosure provides a stacked structure and a design method of its bonding layer, which can effectively reduce design costs and improve efficiency.

The design method of the bonding layer of the stacked structure according to the disclosure includes the following steps. A first stacked structure is provided, in which the first stacked structure is formed by stacking and bonding of multiple wafers, and the first stacked structure includes die regions, bonding test regions, and scribe lines. The scribe lines separate the die regions, and the bonding test regions are located in the scribe lines, in which each of the bonding test regions of the first stacked structure includes a test circuit, and the test circuit of the first stacked structure includes conductive bonding structures formed by bond pads of wafers bonding to each other, in which the bond pads of each of the multiple wafers of the first stacked structure in the bonding test regions have different design parameters. An electrical performance test is conducted on the test circuit of each of the bonding test regions of the first stacked structure. A range of applicable design parameters for bond pads in the die regions of the first stacked structure is determined by a test result of the electrical performance test.

The stacked structure of the disclosure includes a first wafer and a second wafer. The first wafer includes multiple first die regions, first scribe lines, and first bonding test regions. The first scribe lines separate the first die regions. The first bonding test regions are located in the first scribe lines, in which the multiple first bonding test regions include a first zone and a second zone, the first zone includes multiple first bond pads, and the second zone includes multiple second bond pads. The second wafer includes multiple second die regions, second scribe lines, and multiple second bonding test regions. The second scribe lines separate the second die regions. The second bonding test regions are located in the second scribe lines, in which the multiple second bonding test regions include a third zone and a fourth zone, the third zone includes multiple third bond pads, and the fourth zone includes multiple fourth bond pads. The bond pads in the multiple second die regions of the second wafer directly contact corresponding bond pads in the multiple first die regions of the first wafer, the multiple third bond pads in the third zone of the second wafer directly contact the multiple first bond pads in the first zone of the first wafer, and the multiple fourth bond pads in the fourth zone of the second wafer directly contact the multiple second bond pads in the second zone of the first wafer.

Based on the above, the stacked structure of the disclosure, by setting up multiple bonding test regions in the scribe lines, can determine the feasible range of design parameters for bond pads, bonding process parameters, and the quantity of stacked chips in the stacked structure through electrical performance tests on the test circuits of multiple bonding test regions. The design of the bonding layer in the stacked structure may be adjusted according to these obtained feasible ranges without affecting the layout design of the die region in the stacked structure. This can effectively reduce design costs and provide design basis for further miniaturization or variation of future stacked structures.

### BRIEF DESCRIPTION OF THE DRAWINGS

FIG. 1 is a flowchart of a design method of a bonding layer of a stacked structure according to an embodiment of the disclosure.

FIG. 2 is a cross-sectional schematic view of a first stacked structure according to an embodiment of the disclosure.

FIG. 3 is a cross-sectional schematic view of a bonding test region according to an embodiment of the disclosure.

FIG. 4 is a top view schematic diagram of a first wafer of the first stacked structure in FIG. 2 at a bonding interface.

FIG. 5 is a top view schematic diagram of a second wafer of the first stacked structure in FIG. 2 at the bonding interface.

FIG. 6A to FIG. 6C are top view schematic diagrams of some embodiments of bond pads.

FIG. 7 is a relationship graph showing the pitch and shape of the bond pads versus resistance value.

FIG. 8 is a cross-sectional schematic view of the bonding test region according to another embodiment of the disclosure.

FIG. 9 is a relationship graph showing the bonding offset versus bond pad pitch.

FIG. 10 is a relationship graph showing the bonding temperature versus bond pad pitch.

FIG. 11 is a cross-sectional schematic view of the bonding test region according to another embodiment of the disclosure.

FIG. 12 is a relationship graph showing the quantity of stacked wafers versus resistance value.

### DESCRIPTION OF THE EMBODIMENTS

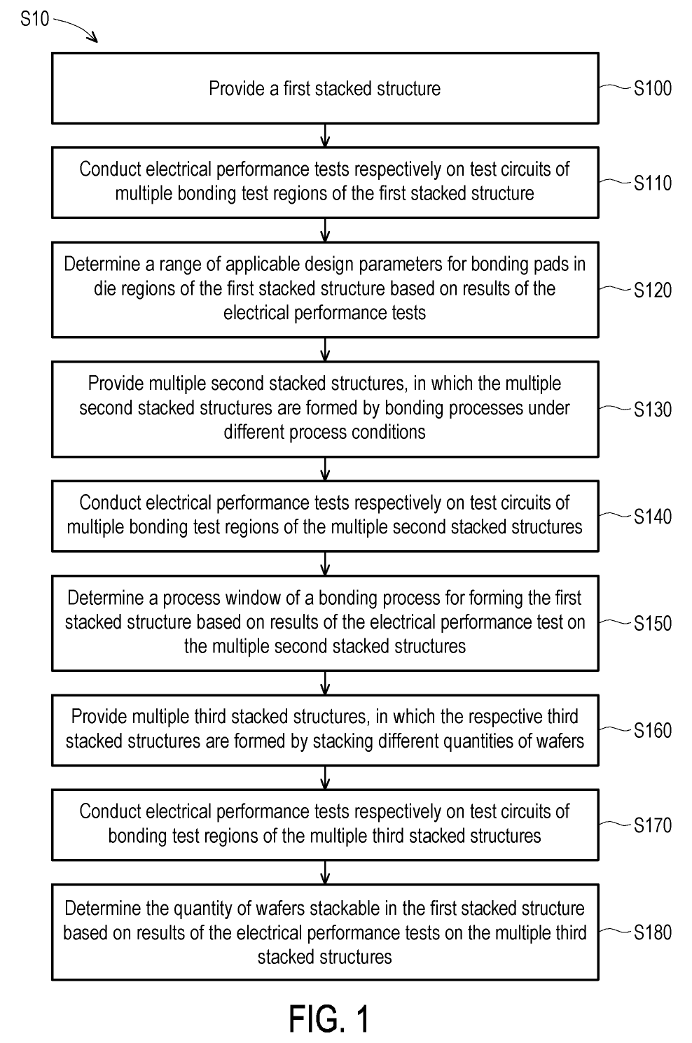

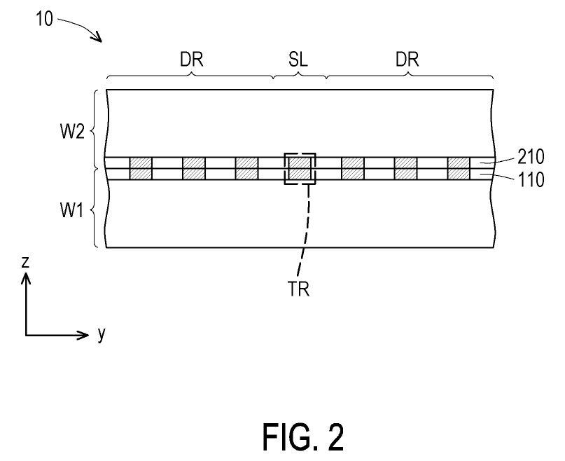

Refer to FIG. 1 to FIG. 5, where FIG. 2 merely schematically illustrates the bonding of a bonding layer 110 of a first wafer W1 and a bonding layer 210 of a second wafer W2, and marks the positions of die regions DR, scribe lines SL, and bonding test regions TR, while omitting other components. A design method S10 of the bonding layer of the stacked structure includes the following steps. First, in block S100, a first stacked structure 10 is provided. The first stacked structure 10 is formed by stacking and bonding of multiple wafers (for example, the first wafer W1 and the second wafer W2). In some embodiments, as shown in FIG. 2 to FIG. 4, the first wafer W1 includes a substrate 100, a bonding layer 110, and an internal connection structure 120, where the bonding layer 110 is disposed above the substrate 100, and the internal connection structure 120 is disposed between the substrate 100 and the bonding layer 110. Similarly, the second wafer W2 includes a substrate 200, a bonding layer 210, and an internal connection structure 220, where the bonding layer 210 is disposed above the substrate 200, and the internal connection structure 220 is disposed between the substrate 200 and the bonding layer 210. The bonding layer 110 of the first wafer W1 and the bonding layer 210 of the second wafer W2 are disposed surface-to-surface and form the first stacked structure 10 through hybrid bonding. In some embodiments, the first wafer W1 may be a base wafer, an interposer, or a memory wafer, and the second wafer W2 may be a memory wafer.

In some embodiments, the substrates 100, 200 may include semiconductor materials, such as silicon, germanium, silicon carbide, gallium arsenide, gallium nitride, or other suitable materials. In some embodiments, devices (not shown) may be disposed in or on the substrates 100, 200, such as active components, passive components, or other suitable devices. The internal connection structure 120 may include multiple conductive layers 122 and dielectric layers 124 stacked alternately to provide internal circuit layout for the first wafer W1; the internal connection structure 220 may include multiple conductive layers 222 and dielectric layers 224 stacked alternately to provide internal circuit layout for the second wafer W2.

In some embodiments, the bonding layer 110 may include multiple bond pads 112, multiple bonding vias 114, and a bonding dielectric layer 116. The multiple bond pads 112 and the multiple bonding vias 114 are disposed in the bonding dielectric layer 116. The bonding vias 114 are disposed between the bond pads 112 and the internal connection structure 120 to electrically connect the bond pads 112 with the conductive layers 122 of the internal connection structure 120. On the other hand, the bonding layer 210 may include multiple bond pads 212, multiple bonding vias 214, and a bonding dielectric layer 216. The multiple bond pads 212 and the multiple bonding vias 214 are disposed in the bonding dielectric layer 216. The bonding vias 214 are disposed between the bond pads 212 and the internal connection structure 220 to electrically connect the bond pads 212 with the conductive layers 222 of the internal connection structure 220.

In some embodiments, the multiple bond pads 112 of the first wafer W1 may undergo metal-to-metal bonding with the corresponding multiple bond pads 212 of the second wafer W2, and the bonding dielectric layer 116 of the first wafer W1 may undergo dielectric-to-dielectric bonding with the bonding dielectric layer 216 of the second wafer W2, thereby forming a bonding structure at the interface between the first wafer W1 and the second wafer W2. Through the bond pads 112 and the bond pads 212, the first wafer W1 and the second wafer W2 may be electrically connected to each other to form the first stacked structure 10. In this embodiment, the bonding process of the first wafer W1 and the second wafer W2 is conducted under predetermined process conditions.

In some embodiments, the materials of the conductive layers 122 and 222, the bond pads 112 and 212, and the bonding vias 114 and 214 may include copper, aluminum, gold, tungsten, silver, platinum, titanium, tantalum, the alloys thereof, or other suitable conductive materials. In some embodiments, the materials of the dielectric layers 124 and 224 and the bonding dielectric layers 116 and 216 may include silicon oxide, polyimide, or other suitable dielectric materials.

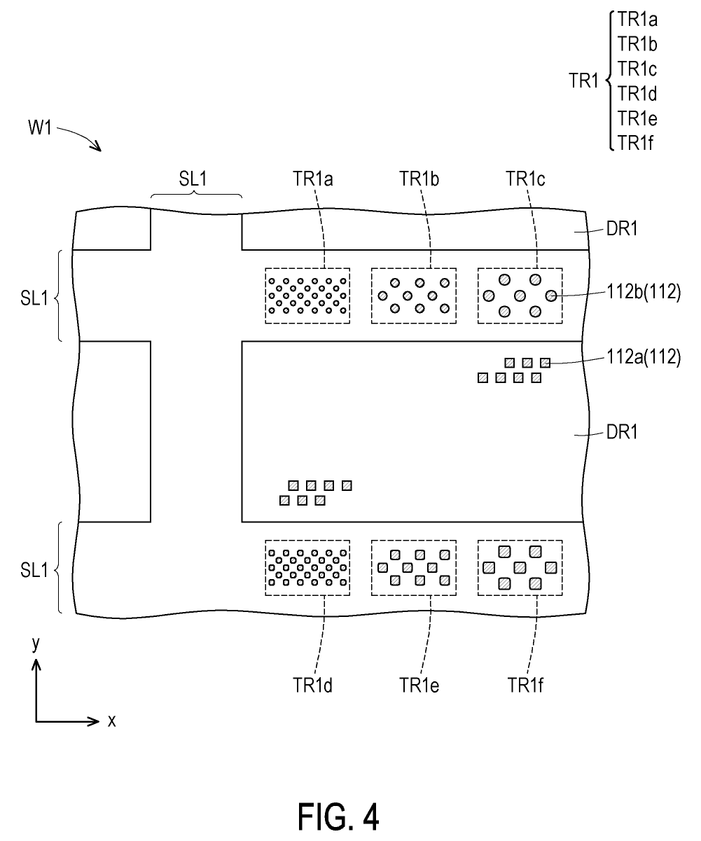

In some embodiments, as shown in FIG. 4, the first wafer W1 may include multiple first die regions DR1, multiple bonding test regions TR1, and first scribe lines SL1. The multiple first die regions DR1 are arranged in an array, and the first scribe lines SL1 separate the multiple first die regions DR1. The first scribe lines SL1 may include multiple scribe lines extending along an x direction and arranged in a y direction, as well as multiple scribe lines extending along the y direction and arranged in the x direction. The multiple bonding test regions TR1 are located in the first scribe lines SL1 to provide the bond pads 112 having different design parameters for subsequent bonding tests. For example, the multiple bonding test regions TR1 may include bonding test regions TR1a, TR1b, TR1c, TR1d, TR1e, and TR1f. In some embodiments, the bonding test regions TR1a, TR1b, TR1c are arranged in a first scribe line SL1 extending along the x direction, while the bonding test regions TR1d, TR1e, TR1f are arranged in another first scribe line SL1 extending along the x direction. However, the disclosure is not limited thereto. The bonding test regions TR1a, TR1b, TR1c, TR1d, TR1e, and TR1f may be disposed in any first scribe line SL1, and the quantity of the bonding test regions may be adjusted according to actual requirements.

In some embodiments, the multiple bond pads 112 may be located in the multiple first die regions DR1 and the multiple bonding test regions TR1. For ease of distinction, the bond pads 112 located in the multiple first die regions DR1 are denoted as bond pads 112a, and the bond pads 112 located in the multiple bonding test regions TR1 are denoted as bond pads 112b.

The bond pads 112a located in the multiple first die regions DR1 have design parameters preset in the initial design stage, while the bond pads 112b located in the multiple bonding test regions TR1 each include different design parameters, where the design parameters of the bond pads may include parameters such as shape, size, and pitch of the bond pads. For example, the bond pads 112b in the bonding test regions TR1a, TR1b, and TR1c are all circular in shape, but the size (for example, diameter) and/or pitch of the bond pads 112 in the bonding test region TR1a is smaller than that of the bond pads 112 in the bonding test region TR1b, and the size (for example, diameter) and/or pitch of the bond pads 112 in the bonding test region TR1b is smaller than that of the bond pads 112 in the bonding test region TR1c. On the other hand, the bond pads 112b in the bonding test regions TR1d, TR1e, and TR1f are all square with rounded corners, but the size (for example, length and/or width) and/or pitch of the bond pads 112b in the bonding test region TR1d is smaller than that of the bond pads 112b in the bonding test region TR1e, and the size (for example, length and/or width) and/or pitch of the bond pads 112b in the bonding test region TR1e is smaller than that of the bond pads 112b in the bonding test region TR1f. In this way, the bond pads 112b having different design parameters may be disposed in different bonding test regions TR1.

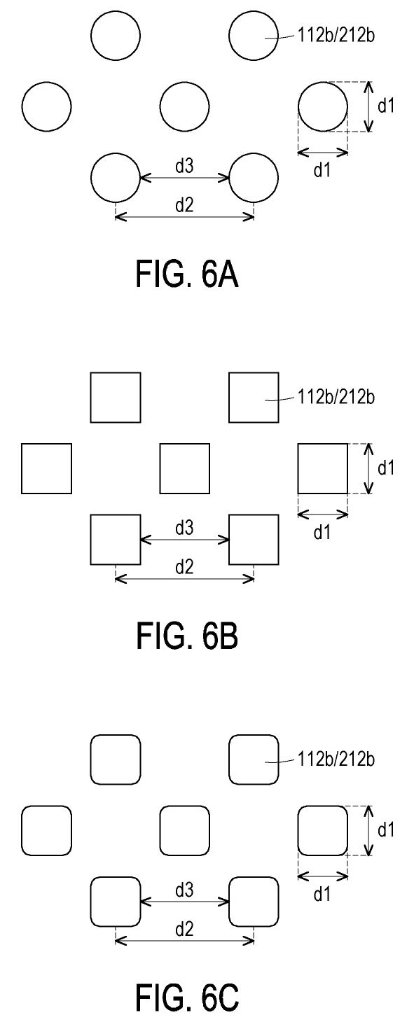

The bond pads in FIG. 6A to FIG. 6C may be bond pads of the first wafer W1 or the second wafer W2. In some embodiments, the shape of the bond pads 112b in the bonding test region TR1 (as viewed from above) may be circular (as shown in FIG. 6A), elliptical, square (as shown in FIG. 6B), rectangular, square with rounded corners (as shown in FIG. 6C), rectangular with rounded corners, triangular, hexagonal, octagonal, or other shapes. In some embodiments, a size d1 of the bond pads 112b in the bonding test region TR1 (for example, width measured in the x direction or length measured in the y direction or diameter of a circle) may be in a range of 0.5 μm to 5 μm. In some embodiments, a pitch d2 of the bond pads 112b in the bonding test region TR1 refers to the distance between the centers of two adjacent bond pads 112, and the pitch d2 may be in a range of 2 μm to 15 μm. In some embodiments, a ratio of the size d1 of the bond pads 112b to a distance d3 of the bonding dielectric layer 116 between two adjacent bond pads 112b (that is, d1/d3) < 0.4 can help improve bonding strength.

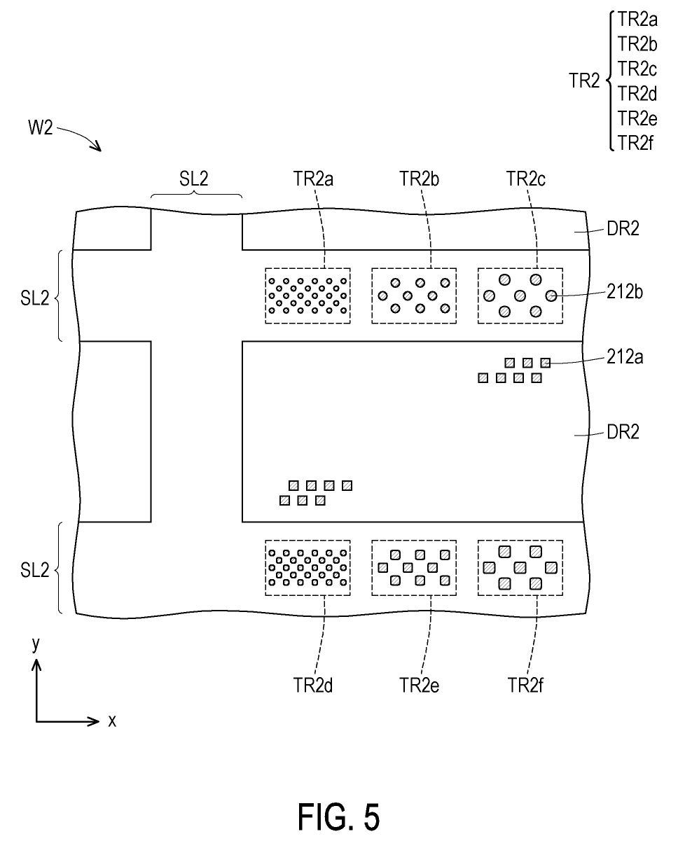

Similarly, as shown in FIG. 5, the second wafer W2 may include multiple second die regions DR2, multiple bonding test regions TR2, and second scribe lines SL2, which correspond to the first die regions DR1, the multiple bonding test regions TR1, and the first scribe lines SL1 of the first wafer W1, respectively. The multiple second die regions DR2 are arranged in an array, and the second scribe lines SL2 separate the multiple second die regions DR2. The second scribe lines SL2 may include multiple scribe lines extending along the x direction and arranged in the y direction, as well as multiple scribe lines extending along the y direction and arranged in the x direction. The multiple bonding test regions TR2 are located in the second scribe lines SL2 to provide the bond pads 212 having different design parameters for subsequent bonding tests. For example, the multiple bonding test regions TR2 may include bonding test regions TR2a, TR2b, TR2c, TR2d, TR2e, and TR2f, which correspond to the bonding test regions TR1a, TR1b, TR1c, TR1d, TR1e, and TR1f of the first wafer W1, respectively. In some embodiments, the bonding test regions TR2a, TR2b, TR2c are arranged in a second scribe line SL2 extending along the x direction, and the bonding test regions TR2d, TR2e, TR2f are arranged in another second scribe line SL2 extending along the x direction. However, the disclosure is not limited thereto. The bonding test regions TR2a, TR2b, TR2c, TR2d, TR2e, and TR2f may be disposed in any second scribe line SL2, and the quantity of the bonding test regions TR2 may be adjusted according to actual requirements, provided that the positions and quantities of the multiple bonding test regions TR2 correspond to the positions and quantities of the multiple bonding test regions TR1.

In some embodiments, the multiple bond pads 212 may be located in the multiple second die regions DR2 and the multiple bonding test regions TR2. For ease of distinction, the bond pads 212 located in the multiple second die regions DR2 are denoted as bond pads 212a, and the bond pads 212 located in the multiple bonding test regions TR2 are denoted as bond pads 212b.

The bond pads 212a located in the multiple second die regions DR2 have design parameters preset in the initial design stage, while the bond pads 212b located in the multiple bonding test regions TR2 each include different design parameters and correspond to the bond pads 112b in the multiple bonding test regions TR1 to facilitate bonding with the bond pads 112b in the multiple bonding test regions TR1. For example, the shape, size, and pitch of the bond pads 212b in the bonding test regions TR2a, TR2b, and TR2c are substantially the same as that of the corresponding bond pads 112b in the bonding test regions TR1a, TR1b, and TR1c. Therefore, the shape of the bond pads 212b in the bonding test regions TR2a, TR2b, and TR2c are all circular, the size (for example, diameter) and/or pitch of the bond pads 212 in the bonding test region TR2a is smaller than the size that of the bond pads 212 in the bonding test region TR2b, and the size (for example, diameter) and/or pitch of the bond pads 212 in the bonding test region TR2b is smaller than that of the bond pads 212 in the bonding test region TR2c. On the other hand, the shape, size, and pitch of the bond pads 212b in the bonding test regions TR2d, TR2e, and TR2f are substantially the same as that of the corresponding bond pads 112b in the bonding test regions TR1d, TR1e, and TR1f. Therefore, the shape of the bond pads 212b in the bonding test regions TR2d, TR2e, and TR2f are all square with rounded corners, the size (for example, length and/or width) and/or pitch of the bond pads 212b in the bonding test region TR2d is smaller than the size (for example, diameter) and/or pitch of the bond pads 212b in the bonding test region TR2e, and the size (for example, length and/or width) and/or pitch of the bond pads 212b in the bonding test region TR2e is smaller than the size (for example, diameter) and/or pitch of the bond pads 212b in the bonding test region TR2f. In this way, the bond pads 212b having different design parameters may be disposed in different bonding test regions TR2.

In some embodiments, the multiple second die regions DR2 of the second wafer W2 correspond to the multiple first die regions DR1 of the first wafer W1, and the bond pads 212a of the multiple second die regions DR2 are bonded to the bond pads 112a of the multiple first die regions DR1 to form the die regions DR of the first stacked structure 10. The second scribe lines SL2 of the second wafer W2 correspond to the first scribe lines SL1 of the first wafer W1, and together they form the scribe lines SL of the first stacked structure 10. The multiple bonding test regions TR2 of the second wafer W2 correspond to the multiple bonding test regions TR1 of the first wafer W1, and the bond pads 212b of the multiple bonding test regions TR2 are bonded to the bond pads 112b of the multiple bonding test regions TR1 to form the multiple bonding test regions TR of the first stacked structure 10. In other words, the first stacked structure 10 includes the multiple die regions DR, the multiple bonding test regions TR, and the scribe lines SL. The multiple die regions DR are arranged in an array and separated by the scribe lines SL, and the multiple bonding test regions TR are located in the scribe lines SL.

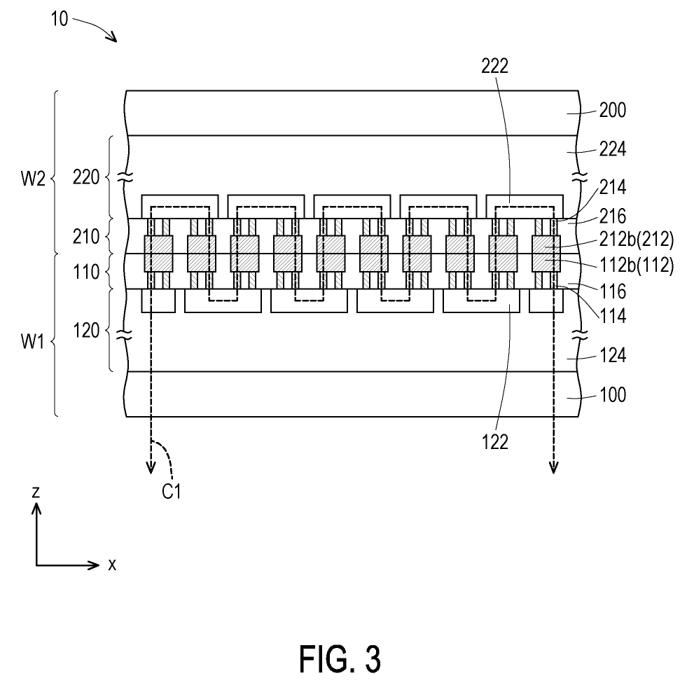

In some embodiments, each of the multiple bonding test regions TR of the first stacked structure 10 includes a test circuit C1 (shown by dashed lines in FIG. 3, where arrows indicate external connections for electrical performance test), and the test circuit C1 extends between the first wafer W1 and the second wafer W2. In some embodiments, the test circuit C1 is a daisy chain circuit, with half of the circuit in the first wafer W1 and the other half in the second wafer W2. Therefore, the test circuit C1 includes multiple conductive bonding structures formed by the bonding of the bond pads 112b in the bonding test region TR1 of the first wafer W1 and the bond pads 212b in the bonding test region TR2 of the second wafer W2. The multiple conductive bonding structures may be interconnected through the bonding vias 114 and the conductive layer 122, as well as through the bonding vias 214 and the conductive layer 222, to form the test circuit C1.

Refer to FIG. 1. In block S110, electrical performance tests are conducted respectively on the test circuits C1 of the multiple bonding test regions TR of the first stacked structure 10, such as resistance value measurements or other electrical performance tests.

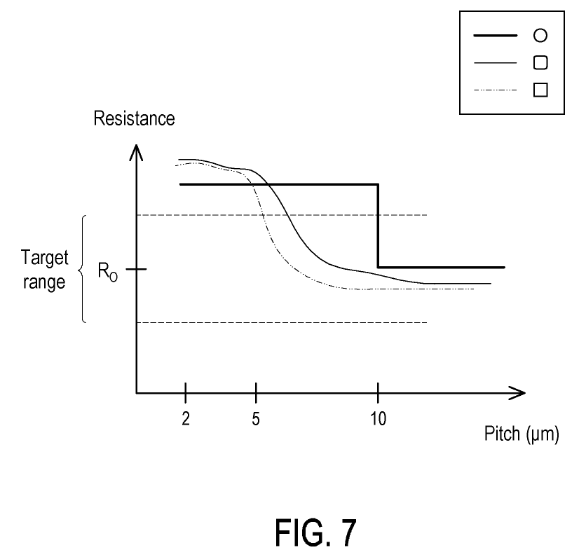

Refer to FIG. 1. In block S120, the range of applicable design parameters for the bond pads 112, 212 of the first stacked structure 10 is determined based on the results of the electrical performance tests. In some embodiments, a relationship graph may be plotted between the measured resistance values and the corresponding design parameters of the bond pads 112b, 212b to determine the range of applicable design parameters for the bond pads 112b, 212b. For example, as shown in FIG. 7, a relationship graph showing the pitch and shape of the bond pads versus the resistance value may be plotted. From FIG. 7, it may be seen that when the bond pads 112b, 212b are square, and when the pitch of the bond pads 112b, 212b is less than approximately 5 μm, the resistance value of the test circuit C1 is greater than the target range; when the pitch of the bond pads 112b, 212b is approximately 5 μm or more, the resistance value of the test circuit C1 is within the target range. The values indicate that in the case of bond pads 112b, 212b being square, the range of applicable pitch for the bond pads 112b, 212b is approximately 5 μm or more. When the bond pads 112b, 212b are square with rounded corners, and when the pitch of the bond pads 112, 212 is less than approximately 6 μm, the resistance value of the test circuit C1 is greater than the target range; when the pitch of the bond pads 112b, 212b is approximately 6 μm or more, the resistance value of the test circuit C1 is within the target range. The values indicate that in the case of bond pads 112b, 212b being square with rounded corners, the range of applicable pitch for the bond pads 112b, 212b is approximately 6 μm or more. When the bond pads 112b, 212b are circular, and when the pitch of the bond pads 112b, 212b is less than approximately 10 μm, the resistance value of the test circuit C1 is greater than the target range. When the pitch of the bond pads 112b, 212b is approximately 10 μm or more, the resistance value of the test circuit C1 is within the target range. The values indicate that in the case of bond pads 112b, 212b being circular, the range of applicable pitch for the bond pads 112b, 212b is approximately 10 μm or more. The foregoing examples are intended to clearly illustrate how to determine the range of applicable pitch for the bond pads 112b, 212b based on the results of electrical performance tests, and the disclosure is not limited thereto. It should be understood that the numerical ranges of the above-mentioned pitch are for illustrative purposes only and are not intended to limit the disclosure. Here, the target range for the resistance value may be set as ±5% to ±10% of a target value Rₒ, the target value Rₒ may be set to an appropriate value according to different applications, and the disclosure is not limited thereto. The target range for the resistance value may also be set according to the upper and lower limits of the defined specifications. Similarly, a relationship graph of the size and shape of the bond pads versus the resistance value may be plotted to obtain the range of applicable size for bond pads 112b, 212b with different shapes.

In some embodiments, based on the range of applicable design parameters obtained for the bond pads 112b, 212b as described above, it may be determined whether the design parameters of the bond pads 112a, 212a in the die region DR of the current first stacked structure 10 meet the range of applicable design parameters. If the design parameters of the bond pads 112a, 212a in the die region DR are within the range of applicable design parameters, it indicates that the current design parameters of the bond pads 112a, 212a in the die region DR are feasible. If the design parameters of the bond pads 112a, 212a in the die region DR are outside the range of applicable design parameters, the design parameters of the bond pads 112a, 212a in the current die region DR may be modified based on the obtained range of applicable design parameters for the bond pads 112b, 212b. Since the bonding test region of the first stacked structure 10 is located in the scribe line SL rather than in the die region DR, it is merely necessary to modify the mask design of the bonding layer 110 of the first wafer W1 and the bonding layer 120 of the second wafer W2 according to the obtained range of applicable design parameters, without affecting the internal design of the die region DR, thereby reducing the overall design cost.

In some embodiments, according to current process conditions and industry requirements (such as input/output (I/O) count, cost considerations, space considerations, process capabilities), an optimal combination of design parameters for the bond pads 112a, 212a in the die region DR of the first stacked structure 10 may be obtained through the range of applicable design parameters obtained for the bond pads 112b, 212b. Here, the optimal combination of design parameters may refer to the combination of design parameters that can maximize the quantity of I/O bonds, be the easiest to manufacture, or meet other process purposes.

Refer to FIG. 1. In block S130, multiple second stacked structures 20 are provided, in which the multiple second stacked structures 20 are formed by bonding processes under different process conditions. Each of the multiple second stacked structures 20 is formed by stacking and bonding of multiple wafers (for example, a third wafer W3 and a fourth wafer W4). The third wafer W3 has the same structure as the first wafer W1, and the fourth wafer W4 has the same structure as the second wafer W2, so details will not be repeated here.

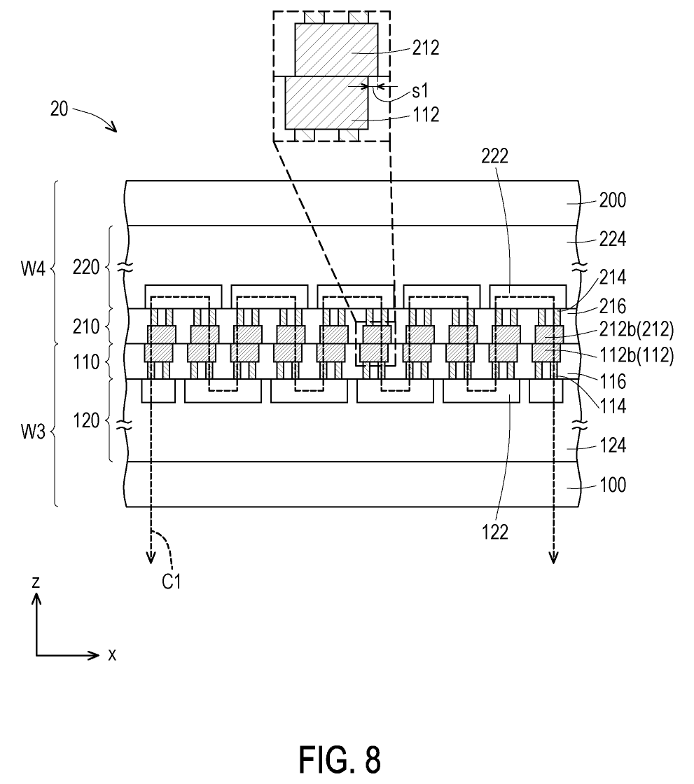

In some embodiments, the process conditions of the bonding process may include bonding temperature, bonding accuracy (or bonding offset), rf (radio frequency) power used in the surface treatment process of the bond pads before bonding, or other process parameters. Taking FIG. 8 as an example, the third wafer W3 and the fourth wafer W4 of the multiple second stacked structures 20 may be intentionally offset during bonding, so that the bond pads 112 (including the bond pads 112a in the first die region DR1 and the bond pads 112b in the multiple bonding test regions TR1) of the third wafer W3 and the corresponding bond pads 212 (including the bond pads 212a in the second die region DR2 and the bond pads 212b in the multiple bonding test regions TR2) of the fourth wafer W4 are offset by a distance s1 (that is, bonding offset) in the horizontal direction (for example, the x direction or the y direction). In some embodiments, the bonding offset may be within a range of 0 to 10% of the size of the bond pads 112, 212. In some embodiments, the range of the bonding offset is defined to be within the specification of the resistance value. In some embodiments, each of the multiple second stacked structures 20 is formed by bonding of the third wafer W3 and the fourth wafer W4 at different bonding temperatures. In some embodiments, each of the multiple second stacked structures 20 is formed by bonding of the third wafer W3 and the fourth wafer W4 under different surface treatment conditions.

Refer to FIG. 1. In block S140, electrical performance tests are conducted respectively on the test circuits C1 in the multiple bonding test regions TR of the multiple second stacked structures 20, such as resistance value measurements or other electrical measurements.

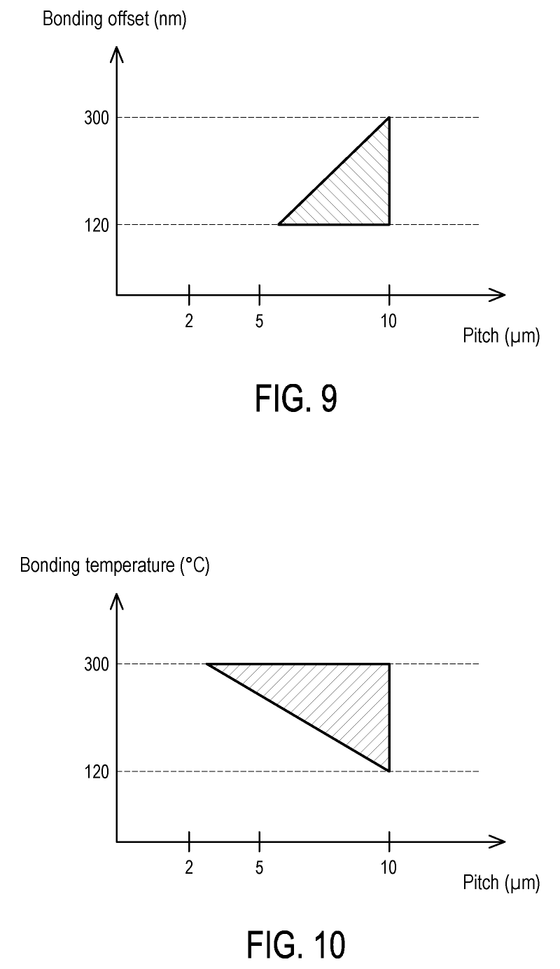

Refer to FIG. 1. In block S150, the process window of the bonding process for forming the first stacked structure 10 is determined based on the results of the electrical performance tests on the multiple second stacked structures 20. In some embodiments, the measured resistance values and corresponding process parameters may be plotted in a relationship graph to determine the process window of the process parameter. Taking FIG. 9 as an example, a relationship graph showing the bonding offset versus bond pad pitch may be plotted under fixed conditions of some design parameters of bond pads and bonding process parameters. In FIG. 9, the hatched area indicates the region where the measured resistance values are within the target range, which means that the bond pads 112, 212 with pitch in this hatched area may allow offset within the corresponding bonding offset range. Taking FIG. 10 as an example, a relationship graph showing the bonding temperature versus bond pad pitch may be plotted under fixed conditions of some design parameters of bond pads and bonding process parameters. In FIG. 10, the hatched area indicates the region where the measured resistance values are within the target range, which means that the bond pads 112, 212 with pitch in this hatched area may allow bonding within the corresponding bonding temperature range. The foregoing examples are intended to clearly illustrate how to determine the process window of the bonding process based on the results of electrical performance tests, and the disclosure is not limited thereto. It should be understood that the numerical ranges of the above-mentioned pitch, bonding offset, and bonding temperature are for illustrative purposes only and are not intended to limit the disclosure. Similarly, relationship graphs of other design parameters of bond pads, bonding process parameters, and resistance values may be plotted, thus obtaining the process window for each bonding process parameter.

In some embodiments, according to current process conditions and industry requirements (such as input/output (I/O) count, cost considerations, space considerations, process capabilities), the combination of bonding process parameters for the first stacked structure 10 may be optimized through the process window of bonding process parameters obtained from testing the multiple second stacked structures 20.

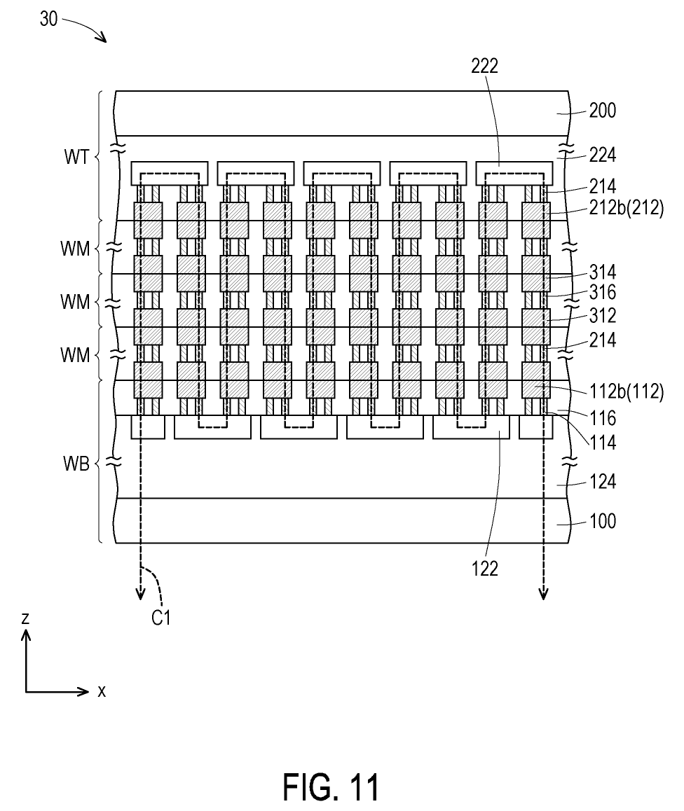

Refer to FIG. 1. In block S160, multiple third stacked structures 30 are provided, in which the respective third stacked structures 30 are formed by stacking different quantities of wafers. As shown in FIG. 11, each of the multiple third stacked structures 30 includes a bottom wafer WB, a top wafer WT, and at least one middle wafer WM. The at least one middle wafer WM is disposed between the bottom wafer WB and the top wafer WT. The bottom wafer WB may, for example, have the same structure as the first wafer W1, and the top wafer WT may, for example, have the same structure as the second wafer W2, so details will not be repeated here. The middle wafer WM may be a memory wafer, for example, similar to the second wafer W2, except that both surfaces opposite to each other of the middle wafer WM are provided with bond pads 312, 314 to correspond and bond with the bond pads of the wafers above and below. For clarity, FIG. 11 merely illustratively shows the connections between the bond pads (including the bond pads 312, 314, 112, 212) of adjacent wafers in the bonding test region TR and the test circuit C1, while omitting other components inside each wafer. Additionally, in the bonding test region TR of the third stacked structure 30, the middle wafer WM further includes conductive interconnects 316 located between the bond pads 312 and 314 to electrically connect the bond pad 312 and bond pad 314 to form part of the test circuit C1. In FIG. 11, the conductive interconnects 316 are illustratively represented by conductive pillars, but the disclosure is not limited thereto. The conductive interconnects 316 may be any structure that can electrically connect adjacent and corresponding the bond pads 312, 314. FIG. 11 illustratively shows three middle wafers WM, but the disclosure is not limited thereto. Each of the multiple third stacked structures 30 may include 1 to 10 or more middle wafers WM.

Refer to FIG. 1. In block S170, electrical performance tests are conducted respectively on the test circuits C1 of multiple bonding test regions TR of the multiple third stacked structures 30, such as resistance value measurements or other electrical performance tests.

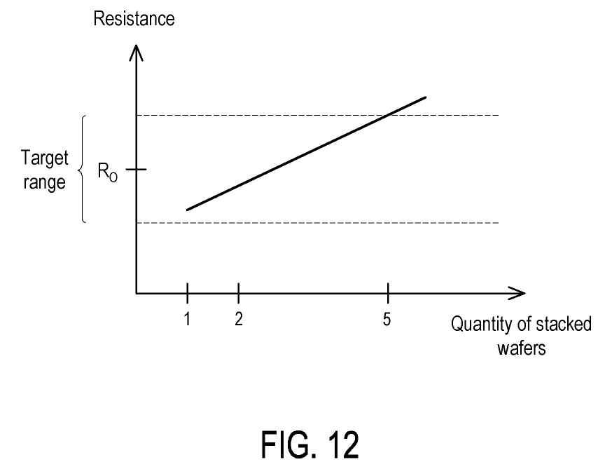

Refer to FIG. 1. In block S180, the quantity of wafers stackable in the first stacked structure 10 is determined based on the results of electrical performance tests on the multiple third stacked structures 30. In some embodiments, a relationship graph may be plotted with the measured resistance values and corresponding quantities of wafer to determine the quantity of wafers stackable in the first stacked structure 10. Taking FIG. 12 as an example, a relationship graph showing the quantity of stacked wafers versus resistance value may be plotted under fixed conditions of bond pad design parameters and bonding process parameters. In FIG. 12, when the quantity of stacked wafers is in a range of 1 to 5, the measured resistance values are within the target range; when the quantity of stacked wafers exceeds 5, the measured resistance values are outside the target range. From this, it may be known that under the fixed conditions of the bond pad design parameters and bonding process parameters, the first stacked structure 10 may stack up to 5 layers of wafers at most. The foregoing example is intended to clearly illustrate how to determine the quantity of wafers stackable in the first stacked structure 10 based on the results of electrical performance tests on the multiple third stacked structures 30, and the disclosure is not limited thereto. It should be understood that the numerical range of the above-mentioned quantity of stacked wafers is for illustrative purposes only and is not intended to limit the disclosure.

In this way, the feasibility of including different quantities of stacked wafers in the first stacked structure 10 may be inferred from results of the electrical performance tests on the third stacked structures 30, and corresponding design modifications may be made early. For example, if it is desired to include stacked wafers exceeding the above-mentioned quantity of wafers stackable in the first stacked structure 10, the resistance value may be reduced and the quantity of stacked wafers may be increased by reducing the height of the bonding layer (including bond pads and/or bonding vias) of each wafer or increasing the pitch of the bond pads.

In summary, the stacked structure of the disclosure, by setting up multiple bonding test regions in the scribe lines, can determine the feasible range of design parameters for bond pads, bonding process parameters, and the quantity of stacked chips in the stacked structure through electrical performance tests on the test circuits of multiple bonding test regions. The design of the bonding layer in the stacked structure may be adjusted according to these obtained feasible ranges without affecting the layout design of the die region in the stacked structure. This can effectively reduce design costs and provide design basis for further miniaturization or variation of future stacked structures.

Although the disclosure has been disclosed by the embodiments, the embodiments are not intended to limit the disclosure. Persons skilled in the art may make some modifications and refinements without departing from the spirit and scope of the disclosure. Therefore, the protection scope of the disclosure should be defined by the appended claims.

What is claimed is:

1. A design method of bonding layer of stacked structure, comprising:
providing a first stacked structure, wherein the first stacked structure is formed by stacking and bonding of a plurality of wafers, the first stacked structure comprises a plurality of die regions, a plurality of bonding test regions, and scribe lines, the scribe lines separate the die regions, the bonding test regions are located in the scribe lines, each of the bonding test regions of the first stacked structure comprises a test circuit, the test circuit of the first stacked structure comprises a conductive bonding structure formed by bonding of bond pads of the wafers to each other, and the bond pads of the wafers of the first stacked structure in each of the bonding test regions have different design parameters;
conducting electrical performance tests on test circuits of the bonding test regions of the first stacked structure respectively; and
determining a range of applicable design parameters for the bond pads in the die regions of the first stacked structure based on results of the electrical performance test.

2. The design method of bonding layer of stacked structure as claimed in claim 1, wherein the design parameters of the bond pads comprise shape, size, and/or pitch.

3. The design method of bonding layer of stacked structure as claimed in claim 1, wherein the first stacked structure comprises:
a first wafer, comprising:
a plurality of first die regions;
first scribe lines, wherein the first scribe lines separate the first die regions; and
a plurality of first bonding test regions located in the first scribe lines, wherein the first bonding test regions comprise a first zone and a second zone, the first zone comprises a plurality of first bond pads, and the second zone comprises a plurality of second bond pads; and
a second wafer, comprising:
a plurality of second die regions;
second scribe lines, wherein the second scribe lines separate the second die regions; and
a plurality of second bonding test regions located in the second scribe lines, wherein the second bonding test regions comprise a third zone and a fourth zone, the third zone comprises a plurality of third bond pads, and the fourth zone comprises a plurality of fourth bond pads,
wherein the bond pads in the second die regions of the second wafer are bonded to corresponding ones of the bond pads in the first die regions of the first wafer, the third bond pads in the third zone of the second wafer are bonded to the first bond pads in the first zone of the first wafer to form a first test circuit, and the fourth bond pads in the fourth zone of the second wafer are bonded to the second bond pads in the second zone of the first wafer to form a second test circuit.

4. The design method of bonding layer of stacked structure as claimed in claim 3, wherein the first bond pads and the third bond pads have substantially same shape, size, and pitch, and the second bond pads and the fourth bond pads have substantially same shape, size, and pitch.

5. The design method of bonding layer of stacked structure as claimed in claim 3, wherein the first test circuit extends between the first zone of the first wafer and the third zone of the second wafer, and the second test circuit extends between the second zone of the first wafer and the fourth zone of the second wafer.

6. The design method of bonding layer of stacked structure as claimed in claim 3, wherein in response to an electrical performance of the first test circuit being within a target range, the design parameters of the first bond pads or the third bond pads are applicable to the bond pads of the first die regions or the second die regions.

7. The design method of bonding layer of stacked structure as claimed in claim 3, wherein the second bonding test region further comprises:
a second conductive layer disposed on the third bond pads; and
second conductive vias disposed between the second conductive layer and the third bond pads to electrically connect the second conductive layer and the third bond pads,
wherein the first bonding test region further comprises:
a first conductive layer disposed on the first bond pads; and
first conductive vias disposed between the first conductive layer and the first bond pads to electrically connect the first conductive layer and the first bond pads,
wherein the first test circuit is formed by the first conductive layer, the first conductive vias, the first bond pads, the second bond pads, the second conductive vias, and the second conductive layer.

8. The design method of bonding layer of stacked structure as claimed in claim 1, further comprising:
providing a plurality of second stacked structures, wherein each of the second stacked structures is formed by stacking and bonding of a third wafer and a fourth wafer, and the second stacked structures are formed by bonding processes under different process conditions;
conducting electrical performance tests on test circuits of bonding test regions of the second stacked structures respectively; and
determining a process window of a bonding process for the first stacked structure based on results of the electrical performance tests on the second stacked structures.

9. The design method of bonding layer of stacked structure as claimed in claim 8, wherein the process conditions comprise bonding temperature, bonding offset, and rf (radio frequency) power for pre-treatment of bond pad surfaces.

10. The design method of bonding layer of stacked structure as claimed in claim 1, further comprising:
providing a plurality of third stacked structures, wherein the respective third stacked structures are formed by stacking and bonding of different quantities of wafers;
conducting electrical performance tests on test circuits of bonding test regions of the third stacked structures respectively; and
determining a range of quantity of wafers stackable in the first stacked structure based on results of the electrical performance tests of the third stacked structures.

11. A stacked structure, comprising:
a first wafer, comprising:
a plurality of first die regions;
first scribe lines, wherein the first scribe lines separate the first die regions; and
a plurality of first bonding test regions located in the first scribe lines, wherein the first bonding test regions comprise a first zone and a second zone, the first zone comprises a plurality of first bond pads, and the second zone comprises a plurality of second bond pads; and
a second wafer, comprising:
a plurality of second die regions;
second scribe lines, wherein the second scribe lines separate the second die regions; and
a plurality of second bonding test regions located in the second scribe lines, wherein the second bonding test regions comprise a third zone and a fourth zone, the third zone comprises a plurality of third bond pads, and the fourth zone comprises a plurality of fourth bond pads,
wherein bond pads in the second die regions of the second wafer directly contact corresponding ones of the bond pads in the first die regions of the first wafer, the third bond pads in the third zone of the second wafer directly contact the first bond pads in the first zone of the first wafer, and the fourth bond pads in the fourth zone of the second wafer directly contact the second bond pads in the second zone of the first wafer.

12. The stacked structure as claimed in claim 11, wherein a shape of the first bond pads is different from a shape of the second bond pads.

13. The stacked structure as claimed in claim 11, wherein a size of the first bond pads is different from a size of the second bond pads.

14. The stacked structure as claimed in claim 11, wherein a pitch of the first bond pads is different from s pitch of the second bond pads.

15. The stacked structure as claimed in claim 11, further comprising:
a first test circuit extending between the first zone of the first wafer and the third zone of the second wafer; and
a second test circuit extending between the second zone of the first wafer and the fourth zone of the second wafer.
